(19) United States
(12) Patent Application Publication
(10) Pub. No.: US 2006/0283985 A1
(43) Pub. Date: Dec. 21, 2006

(54) Ultra-fine spray-jetting nozzle

(75) Inventors: Hiroshi Ikeuchi, Hyogo (JP); Norio Onishi, Osaka (JP); Takeo Mizuno, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: H. IKEUCHI & CO., LTD., Osaka-shi (JP)

(21) Appl. No.: 11/148,421

(22) Filed: Jun. 9, 2005

(51) Int. Cl. B05B 1/26

(52) U.S. Cl. 239/543; 239/544; 239/423; 239/424; 239/433

(57) ABSTRACT

An ultra-fine spray-jetting nozzle includes a liquid passage (37) and a gas passage (41) that is disposed on a peripheral side of the liquid passage (37) through a partitioning wall and communicates with a jetting port (A). An outer surface of the partitioning wall at a jetting port side thereof is formed sectionally polygonal, long circular or elliptic. A peripheral surface of the gas passage (41) is formed sectionally circular. The outer surface of the partitioning wall having the configuration is brought into contact with the sectionally circular peripheral surface of the gas passage (41) at a plurality of positions to circumferentially divide the gas passage (41) at the jetting side into a plurality of gas passages. A gas jetted from jetting ports (A) of a plurality of the separate gas passages is mixed with a periphery of a liquid jetted from the liquid passage (37) to generate spray.

### FIELD OF THE INVENTION

The present invention relates to an ultra-fine spray-jetting nozzle and more particularly to a binary-fluid nozzle that provides ultra-fine particles having an average diameter of several micrometers by spraying a mixture of a liquid such as water, chemicals, oil, and the like and a gas such as air to generate dry fog for which a hand does not feel wet.

### DESCRIPTION OF THE RELATED ART

When dry fog is jetted from a nozzle, i.e., when an average diameter of particles of a fluid jetted from a nozzle is not more than 10 μm and a maximum particle diameter is not more than 50 μm, a hand does not feel wet for dry fog. Because the hand does not feel wet for the dry fog, the dry fog is preferably used for apparatuses of various industrial applications in addition to an air-conditioning nozzle.

The present applicant has proposed a lot of this kind of ultra-fine spray-jetting nozzles as described in Japanese Patent Application Laid-Open No.54-11117 (patent document 1), Examined Japanese Patent Publication No.62-14343 (patent document 2), and Examined Japanese Patent Publication No.4-9104 (patent document 3).

In the binary-fluid nozzles described in the above-described patent documents, the nozzle body is branched in the shape of a character V, and the each of the branched portions is bent to provide a pair of the nozzle-accommodating portions whose front end confront each other. The nozzle tip is mounted in each of the nozzle-accommodating portions. The air passage is formed between the periphery of each nozzle tip and the nozzle-accommodating portion. The liquid passage is formed at the center of the nozzle tip. At the jetting portion, by compressed air jetted from the air passage, the liquid is sucked from the opening disposed at the front end of the liquid passage to generate a straight flow consisting of a mixture of the air and the liquid. Since the jetting portions of a pair of the nozzle tips confront each other, the mixture of the air and the liquid collide with each other to generate an ultra-fine spray.

In the ultra-fine spray-jetting nozzle having the above-described construction, the mixture of the air and the liquid is jetted from each of the jetting portions of the opposed nozzle tips. As a result, both mixtures collide and mix with each other. Droplets atomized by the mixing of the liquid and the gas further collide and mix with each other. Thereby droplets are atomized to a higher extent and have diameters in the range from 1 to 10 μm. That is, ultra-fine spray, namely, the dry fog is generated.

The above-described nozzle is excellent in that it generates the ultra-fine spray. But there is room for improvement in making it difficult for clogging to occur at the jetting portion A disposed at the front end of the nozzle tip and in reducing noise generated by the nozzle.

To reduce a particle diameter, it is preferable to increase the ratio of the volume of the gas to the volume of the liquid by increasing the amount of compressed air. When the ratio of the volume of the gas to the volume of the liquid increases and the amount of the air increases, impurities contained in the air and the water deposit in the vicinity of the jetting port. The deposited impurities are liable to attach to the nozzle tip and the nozzle body and particularly in the vicinity of the jetting port of the air passage, thus causing clogging to occur. According to the experiment conducted by the present inventors, when the ratio of the volume of the gas to the volume of the liquid exceeds 1000, the clogging is apt to occur.

To prevent the occurrence of the clogging, it is effective to reduce the amount of the compressed air by reducing the ratio of the volume of the gas to the volume of the liquid. When the ratio of the volume of the gas to the volume of the liquid is set to less than 1000, the nozzle described in the patent document 1 provides particles having a comparatively large diameter. Thus the nozzle is incapable of generating the ultra-fine spray. FIG. 16 is a graph showing the result of measurement made by the present inventors to compare the ratio of the volume of the gas to the volume of the liquid, the maximum particle diameter, and the clogging generation percentage with each other. The graph indicates that when the ratio of the volume of the gas to the volume of the liquid is set to not less than 1000, the particle diameter decreases but the clogging is liable to occur and that when the ratio of the volume of the gas to the volume of the liquid is set to less than 1000, the occurrence of the clogging decreases but the particle diameter increases.

It is conceivable to prevent the occurrence of the clogging by preventing contamination of impurities contained in the water and the air. The impurities include calcium and silica contained in the water, and a sealing agent and machining oil that attach to a pipe for supplying the water and the compressed air.

When pure water is utilized by applying the water to a demineralizer, the impurities can be removed to some extent. But it is difficult to completely remove the calcium and the silica dissolved in the water. Foreign matters are liable to be contained in the air in a dusty environment. Even though the air is applied to an air filter, it is difficult to completely remove the foreign matters that deposit on a slight sectional area of the air passage, thus causing the occurrence of the clogging.

It is very difficult to effectively prevent the generation of the clogging. It is necessary to perform a maintenance work for the nozzle in which the clogging occurs. Thus the nozzle causes a low workability.

To generate the ultra-fine spray, it is necessary to increase the amount of the compressed air by increasing the ratio of the volume of the gas to the volume of the liquid and reduce the sectional area of the air passage. When the sectional area of the air passage is reduced, a big sound is liable to be generated by the nozzle. That is, the nozzle produces noise in a quiet environment. When the ratio of the volume of the gas to the volume of the liquid is increased, the cost increases.

Patent document 1: Japanese Patent Application Laid-Open No.54-111117

Patent document 2: Examined Japanese Patent Publication No.62-14343

Patent document 3: Examined Japanese Patent Publication No.4-9104

### SUMMARY OF THE INVENTION

The present invention has been made in view of the above-described problems. Therefore it is an object of the present invention to provide an ultra-fine spray-jetting nozzle producing ultra-fine spray in which the average particle diameter of droplets is not more than 10 μm and a maximum particle diameter is not more than 50 μm so that occurrence of clogging is prevented and a low sound is generated by the nozzle and the cost is reduced by decreasing the ratio of the volume of the gas to the volume of the liquid.

To solve the above-described problem, the first invention provides an ultra-fine spray-jetting nozzle including a liquid passage and a gas passage that is disposed on a peripheral side of the liquid passage through a partitioning wall and communicates with a jetting port. An outer surface of the partitioning wall at a jetting port side thereof is formed sectionally polygonal, long circular or elliptic; a peripheral surface of the gas passage is formed sectionally circular; the outer surface of the partitioning wall having the configuration that is not circular is brought into contact with the sectionally circular peripheral surface of the gas passage at a plurality of positions to circumferentially divide the gas passage at the jetting side into a plurality of gas passages.

Alternatively the outer surface of the partitioning wall is formed sectionally circular; the peripheral surface of the gas passage at the jetting port side is formed sectionally polygonal, long circular or elliptic; the outer surface of the partitioning wall is brought into contact with the peripheral surface of the gas passage having the configuration that is not circular at a plurality of positions to circumferentially divide the gas passage at the jetting side into a plurality of gas passages. A gas jetted from jetting ports of a plurality of the separate gas passages is mixed with a periphery of a liquid jetted from the liquid passage to generate spray.

In the first invention, as described above, the jetting side of the gas passage where impurities are most liable to clog is circumferentially divided into a plurality of passages each having a small sectional area. Further as described above, owing to the combination of a sectionally circular configuration, sectionally polygonal configuration, and the like that is not a circular configuration, the area of each gas passage has a large central portion and a small side portion. According to the present inventors' experiment, this configuration allows the gas to flow mainly through the large portion. Thus it is possible to make it difficult for impurities contained in the fluid to clog.

The pressure of the gas can be increased because the sectional area of each of the separate gas passages is reduced. As a result, the amount of the gas to be supplied can be reduced. Therefore it is possible to reduce the impurities contained in air used as the gas mainly. Consequently the occurrence of the clogging can be restrained.

The gas passage open at the jetting port is partitioned into a plurality of passages to reduce the amount of the gas flowing through each gas passage. Therefore it is possible to reduce noise generated at a jetting time.

When the amount of the gas to be supplied is reduced, as described above, the diameters of particles are liable to become large. In the present invention, the gas passage is divided into a plurality of passages to reduce the sectional area of each gas passage. Therefore the pressure of the gas is increased. Consequently when the liquid and the gas mix with each other, the liquid can be atomized.

According to the present inventors' experiments, it has been confirmed that by setting the ratio of the volume of the gas to be supplied to the gas passage to that of the liquid to be supplied to the liquid passage to not less than 800 and less than 1000, it is possible to prevent the occurrence of the clogging of the impurities and generate ultra-fine spray whose maximum particle diameter is not more than 50 μm.

As the gas to be used, it is possible to preferably use compressed air supplied by a compressor and a pressurized air supplied by a blower.

Preferably, a jetting port of the liquid passage is projected outward from the jetting port of the gas passage; and the gas is jetted from the jetting port of the gas passages to the periphery of the liquid jetted from the liquid passage to mix the liquid and the gas with each other externally. It is preferable that jetting portions each including the liquid passage and the gas passage are disposed in confrontation with each other at a predetermined interval and at a predetermined angle; and mixture fluids of the gas and the liquid which have been generated externally at each of the jetting portions collide and mix with each other.

By further colliding and mixing the mixture fluid of the gas and the liquid which have been generated externally at each of the jetting portions, it is possible to set the average diameter of particles of droplets to the range of 1 μm to 10 μm. This construction allows the droplet to be atomized to a higher extent.

The liquid passage is formed along an axis of a first nozzle tip fitted on a tip-accommodating portion of a nozzle body; and the partitioning wall is constructed of a peripheral wall of the first nozzle tip. The gas passage is formed between the first nozzle tip and an inner peripheral surface of the tip-accommodating portion or between a second nozzle tip fitted on the tip-accommodating portion and the first nozzle tip; and a peripheral wall of the gas passage is constructed of the tip-accommodating portion or the second nozzle tip.

That is, the liquid passage and the gas passage may be constructed of the nozzle body and the first nozzle tip. Alternatively, the nozzle tip may be constructed of the first nozzle tip disposed at the center thereof and the second nozzle tip fitted on the first nozzle tip, and the second nozzle tip may be fixed to the inner surface of the tip-accommodating portion of the nozzle body.

Which of the above-described methods is used depends on whether metal or resin is used as the material for composing the nozzle and whether press working, cutting work and the like or resin molding is adopted as the method for forming the nozzle.

It is preferable that the sectional areas of a plurality of the gas passages are equal to each other. Supposing that a total of the sectional areas of a plurality of the gas passages is S1 and that a sectional area of a portion of the liquid passage surrounded with the gas passages is S2, a ratio of S1 to S2 is set to 5:1 to 5:2.

The ratio of the total S1 of the sectional areas of the gas passages to the sectional area S2 of the liquid passage is a preferable range found in the experiment conducted by the present inventors.

Supposing that the sectional area of each of the separate gas passages is S3 and that the sectional area of the liquid passages is S2, it is preferable to set the ratio of S3 to S2 to 10:10 to 9:10.

The ratio of the sectional area of the gas passage to that of the liquid passage is selected by setting the sectional area of one of separate gas passages to the range in which the clogging of impurities is suppressed and by setting the ratio of the volume of the gas to that of the liquid to the range of not less than 800 and less than 1000.

It is preferable that the inner peripheral surface or/and the peripheral surface of each of a plurality of the separate gas passages are coated with a film made of fluororesin.

Coating the inner peripheral surface or/and the peripheral surface of each of the separate gas passages with the above-described coating film is particularly effective when the nozzle body and the nozzle tip are made of metal. The coating film makes it difficult for the impurities contained in the gas to attach to the inner peripheral surface or/and the peripheral surface of each of the separate gas passages. Thus the coating film is effective for preventing the clogging of the impurities.

When the nozzle body having the tip-accommodating portion and the nozzle tip are not made of metal but made of resin, it is preferable to use fluororesin because it has a favorable slip characteristic. Thereby it is possible to effectively prevent the clogging of the impurities.

It is preferable to project the jetting port of the liquid passage outward by 0.3 to 0.8 mm from the jetting port of the gas passage; set an angle formed between axes of the opposed jetting portions to 70° to 160°; and set a distance from each of the jetting portions to a point of collision of fluids to 3 to 15 mm.

Preferably, each of the separate gas passages has a substantially equal sectional area in an axial direction in a range from a gas inlet side to a gas-jetting port; a diameter of a peripheral wall of the liquid passage projected from the gas-jetting port decreases outward gradually; and a diameter of an inner peripheral surface of the jetting port of the liquid passage increases outward gradually.

Because the sectional area of each of the separate gas passages is not increased at the front end portion of the jetting side, it is possible to prevent the gas jetted to the periphery of the liquid from being dispersed outward. On the other hand, the liquid jetted from the center of the nozzle tip in its radial direction is dispersed radially outward. Thereby it is possible to accelerate the mixing of the liquid and the gas and atomize the liquid by means of the pressurized gas.

It is preferable to set a cone angle of a portion of the jetting-side peripheral wall of the liquid passage projected from the gas passage is set to a range from 15° to 40°; and a cone angle of the jetting port of the liquid passage is set to a range from 90° to 170°.

In the experiment conducted by the present inventors, they have found that the above range is preferable in setting the average particle diameter of droplets to the range of 1 μm to 10 μm.

The second invention provides a gas passage having a resin portion forming a smooth surface on at least an inner peripheral surface thereof is provided on a peripheral side of a liquid passage; a jetting port of the liquid passage is projected outward by 0.3 to 0.8 mm from a jetting port of the gas passage; a gas is jetted from the jetting port of the gas passages to a periphery of a liquid jetted from the liquid passage to mix the liquid and the gas with each other externally; jetting portions each including the liquid passage and the gas passage are disposed in confrontation with each other; an angle formed between axes of the opposed jetting portions is set to 70° to 160°; a distance from each of the jetting portions to a point of collision of fluids is set to 3 to 15 mm; and mixture fluids of the gas and the liquid which have been generated externally at each of the jetting portions collide and mix with each other to set an average particle diameter of droplets to a range of 1 μm to 10 μm and a maximum particle diameter to not more than 50 μm. A ratio of a volume of the gas to be supplied to the gas passage to a volume of the liquid to be supplied to the liquid passage is set to not less than 800 and less than 1000.

Preferably, the resin portion formed on the inner surface of the liquid passage is made of fluororesin; a cone angle of a portion of the jetting-side peripheral wall of the liquid passage projected from the gas passage is set to a range from 15° to 40°; and a cone angle of the jetting port of the liquid passage is set to a range from 90° to 170°.

The nozzle of the second invention is different from that of the first invention in that the gas passage is not partitioned into a plurality of passages. In the second invention, the ratio of the volume of the gas to that of the liquid is set to less than 1000 to reduce the amount of the gas, and further the inner peripheral surface of the gas passage is coated with the fluororesin. Thereby it is possible to prevent clogging of impurities and reduce noise.

The third invention provides component parts on which the ultra-fine spray-jetting nozzle having the above-described construction is mounted. The component parts include an air conditioner, a humidifier, a cooler, and the like used for industrial use.

As described above, the ultra-fine spray-jetting nozzle of the present invention have the construction of suppressing the occurrence of the clogging of the impurities. Thereby it is possible to reduce the number of maintenance times. Thus the ultra-fine spray-jetting nozzle contributes to the enhancement of productivity by utilizing it for industrial use.

Further the ultra-fine spray-jetting nozzle is capable of reducing a jet sound generated by the nozzle. Thus it is possible to prevent noise from being generated by the nozzle, when an air conditioner or the like on which the nozzle is mounted is used in a quiet environment.

Even though the ratio of the volume of the gas to that of the liquid is set to less than 1000, the average particle diameter can be reduced to about 10 μm. Therefore it is possible to reduce the cost.

### BRIEF DESCRIPTION OF THE DRAWINGS

FIG. 1 shows a nozzle according to a first embodiment of the present invention.

FIG. 2 is a partly sectional view of the nozzle of the first embodiment.

FIG. 3 is a sectional view showing main portions of FIG. 2.

FIG. 4 is a left side view of FIG. 3.

FIG. 5 is a sectional view taken along a line V-V of FIG. 3.

FIG. 6 is a partly enlarged sectional view of FIG. 3.

FIG. 7 is a sectional view showing a modification of FIG. 1.

FIG. 8 is a sectional view showing main portions of a nozzle of a second embodiment.

FIGS. 9A through 9D are sectional views showing other embodiments of a gas passage.

FIG. 10 is a sectional view showing a third embodiment.

FIG. 11 is a sectional view showing a modification of the third embodiment.

FIG. 12 is a sectional view showing a fourth embodiment.

FIG. 13 shows a fifth embodiment, in which FIG. 13A is a front view showing a jetting portion; and FIG. 13B is sectional view showing main portions of an entire nozzle.

FIG. 14 is a plan view showing a sixth embodiment.

FIG. 15 is a sectional view showing the sixth embodiment.

FIG. 16 is a graph showing the relationship among the ratio of the volume of a gas to the volume of a liquid, particle diameters, and clogging.

### DETAILED DESCRIPTION OF THE PREFERRED EMBODIMENTS

A nozzle according to an embodiment of the present invention is described below with reference to the drawings.

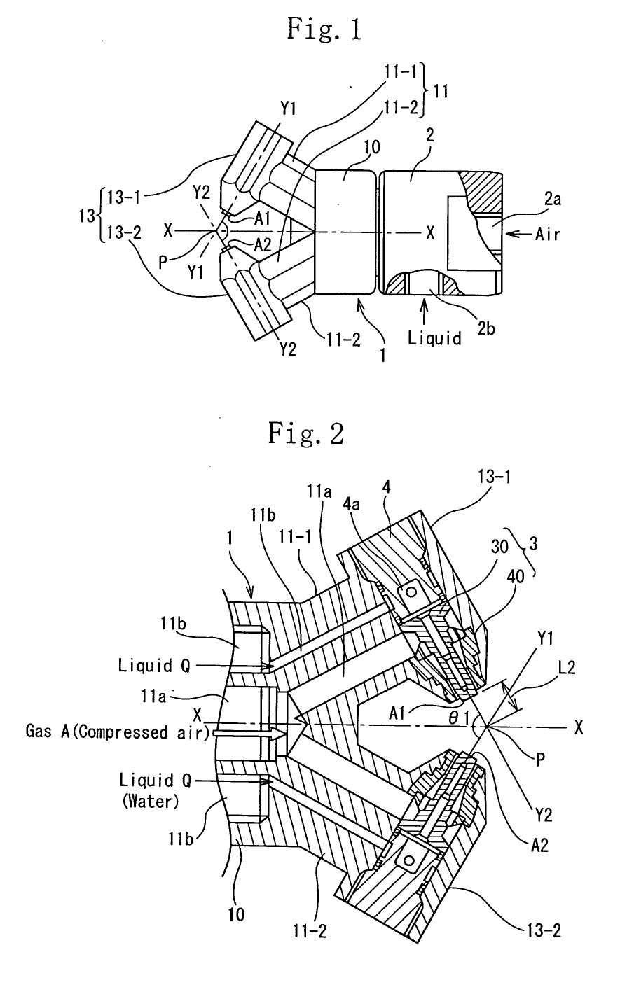

FIGS. 1 through 6 show the first embodiment of the present invention. In the nozzle of the first embodiment, water is used as a liquid and compressed air is used as a gas. The nozzle is mounted on an air conditioner.

The nozzle of the first embodiment has a nozzle tip composed a first nozzle tip and a second nozzle tip combined with the first nozzle tip. The nozzle has a nozzle body 1; an adapter 2, removably coupled with a rear end of the nozzle body 1, for supplying the liquid and the gas to the nozzle body 1; and a nozzle tip 3, composed of a first nozzle tip 30 and a second nozzle tip 40, both of which are mounted in a tip-accommodating portion 13 of the nozzle body 1. The first nozzle tip 30 and the second nozzle tip 40 are made of metal. The nozzle body 1 and the adapter 2 are made of resin.

The nozzle body 1 includes a branch portion 11 (11-1, 11-2) branched in the shape of a character V from a front end surface of a cylindrical portion 10 whose rear end is connected with the adapter 2; and a tip-accommodating portion 13 (13-1, 13-2) disposed at the front end of each branch portion 11 with the tip-accommodating portion 13 inclining with respect to jetting sides thereof in proximity to each other.

The nozzle tip 3 (3-1, 3-2) and plug 4 (4-1, 4-2) are fitted in each of the tip-accommodating portions 13 (13-1, 13-2) confronting each other. Axes (axis of nozzle tip) Y1-Y1 and Y2-Y2 of spray jetted from front-end jetting portions A (A1, A2) of the opposed nozzle tips 3 ((3-1, 3-2) intersect with each other at a point P present on an axis X-X of the cylindrical portion 10 of the nozzle body 1.

The angle θ formed between the axes Y1-Y1 and Y2-Y2 is set to the range of 70° to 160°. The distance L2 between the jetting portion A1 and the point P and the distance between the jetting portion A2 and the point P is set to the range of 3 mm to 15 mm respectively.

In a passage of the nozzle body 1 for the liquid (water) Q and the gas (air), a gas inlet path 2a is formed in the adapter 2 along the axis of the nozzle body 1, and a liquid inlet path 2b open on a peripheral surface of the nozzle body 1 is formed in the adapter 2. At the branch portion 11, the gas inlet path 2a communicates with a gas passage 11a, and the liquid inlet path 2b communicates with a liquid passage 11b.

Inside the tip-accommodating portion 13, the gas passage 11a communicates with a gas passage 3a axially formed in the nozzle tip 3 disposed at the peripheral side thereof. The liquid passage 11b communicates with a liquid passage 4a, formed axially inside the plug 4, which communicates with a liquid passage formed axially inside the nozzle tip 3. Similarly to the above-described patent document 1, at the front-end jetting portion A (A1, A2) of the nozzle tip 3, the gas A jetted from the gas passage axially disposed on the peripheral side of the nozzle tip 3 sucks the liquid Q from a liquid passage 3b disposed axially in the center of the nozzle tip 3 to mix the gas and the liquid with each other to generate a mixture fluid. Mixture fluids jetted from the jetting portion A1 and A2 collide at the intersection point P.

The opposed nozzle tips 3 (3-1, 3-2) have the same configuration which is described in detail below.

The nozzle tip 3 is composed of the first nozzle tip 30 disposed at the radially central portion thereof and having the liquid passage formed along the axis of the nozzle tip 3; and the second nozzle tip 40 fitted on the first nozzle tip 30 with the gas passage formed at the jetting side of the nozzle tip 3 and fixedly fitted in the tip-accommodating portion 13 of the nozzle body 1.

Therefore a partitioning wall disposed between the liquid passage and the gas passage is constructed of the peripheral wall of the first nozzle tip 30, and the peripheral wall of the gas passage is constructed of the second nozzle tip 40.

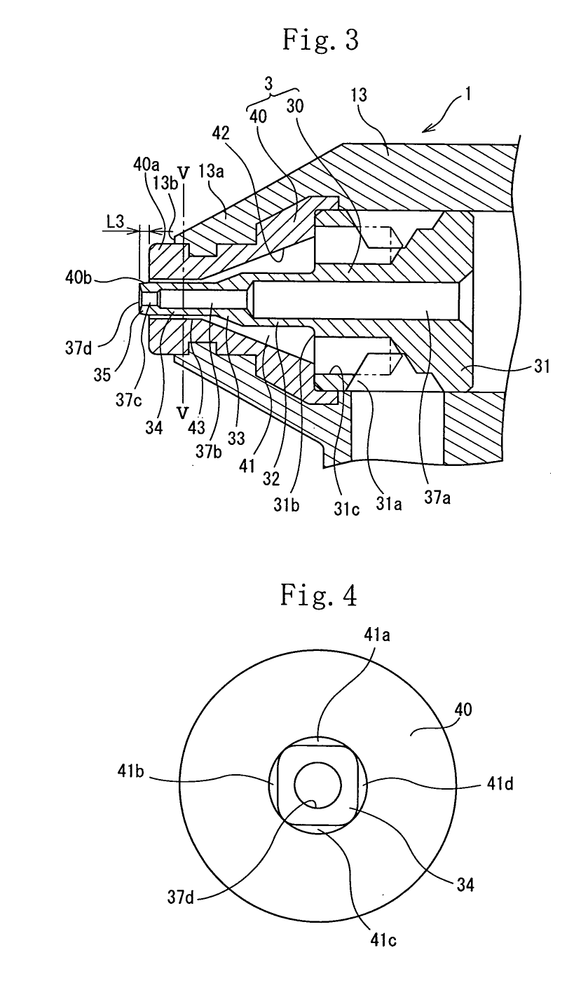

As shown in FIG. 3, the first nozzle tip 30 has a large-diameter portion 31 continuous with the plug 4, an intermediate-diameter cylindrical portion 32 continuous with the large-diameter portion 31, and a square pillar portion 34 continuous with a front end of the intermediate-diameter cylindrical portion 32 through a conic cylindrical portion 33. The outer configuration of the square pillar portion 34 is sectionally square. The first nozzle tip 30 further includes a conic cylindrical portion 35, smaller than the square pillar portion 34 in the diameter thereof, which is formed continuously with the jetting side (front end) of the square pillar portion 34 and extended to the front end of the nozzle tip 3. The inclination θ3 of the conic cylindrical portion 35 disposed at the front end of the nozzle tip 3 is set to 15° to 40°.

A liquid passage 37 sectionally circular is provided along the axis of the large-diameter portion 31, the intermediate-diameter cylindrical portion 32, the conic cylindrical portion 33, the square pillar portion 34, and the conic cylindrical portion 35. The liquid passage 37 communicates with the liquid passage 4a provided inside the plug 4 connected with the rear end thereof to communicate the liquid passage 11b of the branch portion 11 with the liquid passage 4a. Thus the liquid flows to the liquid passage 37 of the first nozzle tip 30 through the liquid passages 11b, 4a.

The sectional area of a liquid passage 37a of the liquid passage 37 disposed along the axis of the large-diameter portion 31 is set equally to that of the liquid passage 37a thereof disposed along the axis of the intermediate-diameter cylindrical portion 32. The sectional area of a liquid passage 37b ranging forward from the conic cylindrical portion 33, the square pillar portion 34, and to the conic cylindrical portion 35 at a portion in the vicinity of an open portion disposed at the front end thereof is set smaller than that of the liquid passage 37a. The sectional area of a liquid passage 37c proximate to a front end 35a of the conic cylindrical portion 35 is set smallest. The diameter of a front end 37d of the liquid passage 37 serving as a jetting port is tapered outward. As shown in FIG. 6, the front end 37d of the liquid passage 37 has a cone angle θ4 set to the range of 90 to 170°.

The large-diameter portion 31 is fitted in the tip-accommodating portion 13. A gas inlet concavity 31a is formed at approximately the longitudinal center of the peripheral surface of the first nozzle tip 30. A gas passage 31c communicating with the gas inlet concavity 31a and the front end surface 31b of the large-diameter portion 31 is formed inside the large-diameter portion 31. The gas passage 31c communicates with a gas passage 41 disposed between the first nozzle tip 30 and the second nozzle tip 40.

The second nozzle tip 40 is approximately conic and cylindrical and fixedly fitted on an inner surface of a conic jetting-side peripheral wall 13a of the tip-accommodating portion 13 by concave-convex fitting. The second nozzle tip 40 is also fitted on the first nozzle tip 30 in the range from the intermediate-diameter cylindrical portion 32 thereof to the square pillar portion 34 thereof, with a space serving as the gas passage 41 formed between the first nozzle tip 30 and the second nozzle tip 40. A front end 40a of the second nozzle tip 40 is projected from a front end surface 13b of the peripheral wall 13a of the tip-accommodating portion 13. The conic cylindrical portion 35 of the first nozzle tip 30 is projected by a required dimension L3 (0.3 to 0.8 mm) from the center of the front end 40a of the second nozzle tip 40.

An inner peripheral surface of the second nozzle tip 40 is formed as a conic surface 42 in the range in which the second nozzle tip 40 is fitted on the first nozzle tip 30 with the gas passage 41 disposed between the first nozzle tip 30 and the second nozzle tip 40. More specifically, the conic surface 42 is extended in the range from the rear end of the second nozzle tip 40 which contacts the periphery of the front end surface of the large-diameter portion 31 of the first nozzle tip 30 to a position near the rear end of the square pillar portion 34. An inner peripheral surface 43 of the second nozzle tip 40 in the range from the front end of the conic surface 42 to a front end 40b thereof is sectionally circular. The second nozzle tip 40 in the range from the front end of the conic surface 42 to the front end 40b thereof has an equal diameter.

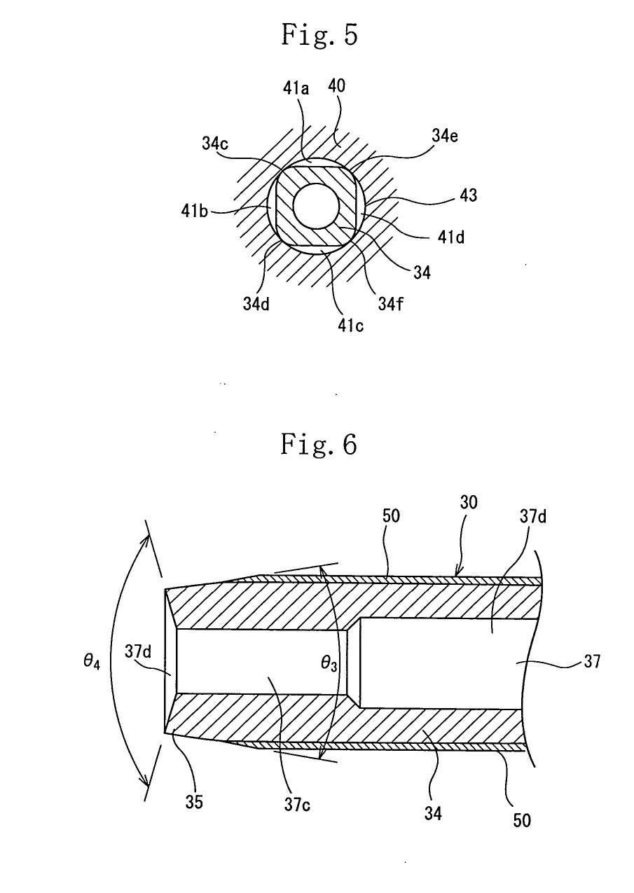

Thus as shown in FIG. 5, the sectionally square pillar portion 34 of the first nozzle tip 30 is fitted on the circular inner peripheral surface 43 of the second nozzle tip 40, with four apexes 34c, 34d, 34e, and 34f of the square pillar portion 34 in contact with the inner peripheral surface 43 of the second nozzle tip 40. Thereby the gas passage formed between the inner peripheral surface 43 of the second nozzle tip 40 and the peripheral surface of the square pillar portion 34 of the first nozzle tip 30 is divided into four gas passages 41a through 41d. The gas passages 41a through 41d are sectionally approximately crescent moon-shaped. The ratio of the total S1 of the sectional areas of the four crescent moon-shaped gas passages to the sectional area S2 of the liquid passage of the square pillar portion 34 is set as follows: S1:S2=5:1 to 5:2.

It is preferable to set the total S1 of the sectional areas of the four crescent moon-shaped gas passages to 0.3 to 0.6 mm² and the sectional area S2 of the liquid passage of the square pillar portion 34 to 0.08 to 0.2 mm².

As described above, the jetting port of the liquid passage is tapered outward. The sectional area of the jetting port (opening for jetting liquid) is set to the range from 0.40 to 0.45 mm².

Accordingly the gas flows dividedly flows into the four gas passages 41a through 41d through an annular passage 41e between the conic surface 42 and the intermediate-diameter cylindrical portion 32. Therefore the gas is dividedly jetted from a front end 40b of the second nozzle tip 40.

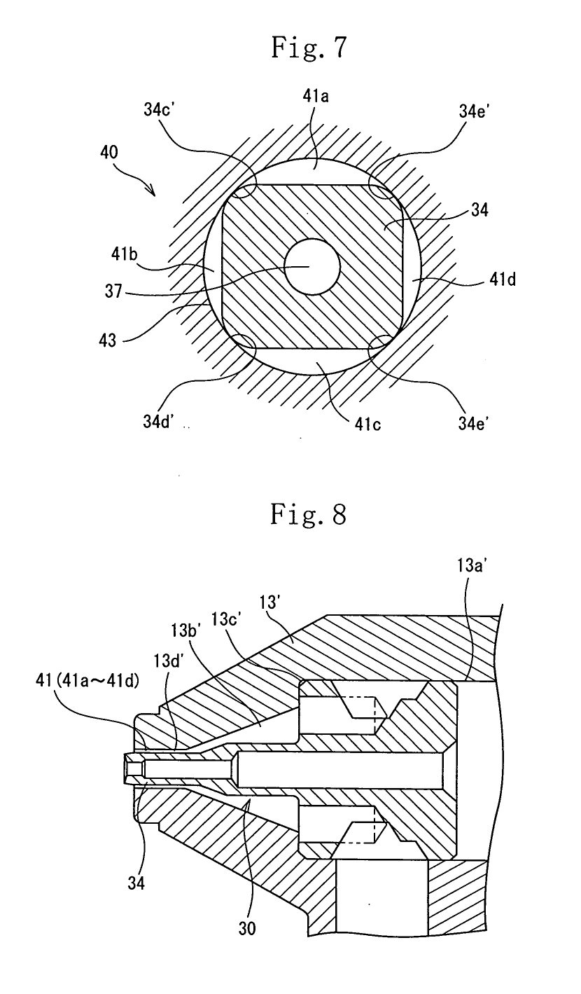

As shown in FIG. 7, rounded surfaces 34c′ through 34f′ are formed at the apexes of the outer surface of the square pillar portion 34 sectionally square. The rounded surfaces 34c′ through 34e′ are brought into contact with the inner peripheral surface 43 of the second nozzle tip 40 to partition the gas passage into four passages.

As shown in FIG. 6, a smooth resin film 50 is formed on at least the peripheral surface of the square pillar portion 34 of the first nozzle tip 30. Although not shown in FIG. 6, a resin film is formed also on the inner peripheral surface 43 of the second nozzle tip 40. In the first embodiment, the inner peripheral surface 43 of the second nozzle tip 40 is coated with Teflon®.

The nozzle tip and other constituent parts of the nozzle may be made of fluororesin.

As described above, in the first embodiment, as the gas A to be supplied to the nozzle, compressed air (about 3 kg/cm³) supplied by a compressor is used. As the liquid Q, water is used. The water A is used after it is applied to a demineralizer. But water does not necessarily have to be applied to the demineralizer.

The operation of the nozzle having the above-described construction will be described below.

At the jetting portions A1 and A2, the gas A is jetted outward from the four separate gas passages 41a through 41d of the nozzle tip 3, and the liquid Q is also jetted from the opening disposed at the front end of the liquid passage 37 to the central position of the jetted gas A. As a result, the gas A and the liquid Q are mixed with each other outside the jetting portions A1 and A2. Consequently droplet of the liquid Q are atomized. Mixture fluids, of the gas A and the liquid Q, which have been generated at the jetting portions A1 and A2 of the nozzle tips 3 collide and mix with each other at the intersection point P. As a result, the droplet is atomized to a higher extent to form a dry fog in which the average of the diameter of particles is not more than 10 μm, namely, 1 μm to 10 μm and the maximum particle diameter is not more than 50 μm.

In a binary-fluid nozzle, a fluid is liable to get clogged in the neighborhood of a jetting port, particularly in the neighborhood of the jetting port of the gas passage. In the first embodiment, the gas passage is divided into the four separate sectionally crescent moon-shaped gas passages 41a through 41d in the neighborhood of the jetting port. Thereby impurities contained in the fluid hardly gets clogged in the neighborhood of the jetting port. According to the present inventors' experiments, it has been confirmed that the clogging generation percentage in the nozzle of the present invention is lower than that in the nozzle described in the patent document 1.

As the first cause, a wide portion 41a-1 is formed at he central portion of each of the gas passages 41a through 41d, and a narrow portion 41a-2 (41b-2, 41c-2, and 41d-2) is generated at both sides of the wide portion 41a-1. The gas flows through the wide portion 41a-1 formed at the central portion of each of the gas passages 41a through 41d. Thus impurities contained in the fluid hardly clog in the wide portion.

As the second cause, because the gas passage is divided into the four passages, the sectional area of one gas passage is much smaller than that of the annular gas passage described in the patent document 1. Thus the pressure of the gas is higher in the former than in the latter. Further the conic cylindrical portion 35 disposed at the front end of the first nozzle tip 30 is projected outward from the front end surface of the second nozzle tip 40. Furthermore the sectional area of each of the four separate gas passages 41a through 41d is not increased outward in the neighborhood of the jetting port. Therefore it is possible to jet the compressed gas without reducing pressure of the gas immediately before the gas is jetted and mix the gas A and the liquid Q with each other outside the jetting port. Consequently, even though the ratio of the volume of the gas to the volume of the liquid is set to 900 which is less than 1000 by reducing the amount of the gas to be supplied, the average of the diameters of jetted particles can be reduced to not more than 10 μm. The ratio of the volume of the gas to the volume of the liquid is set to less than 1000. The dryness of jetted spray is reduced. The amount of the gas to be supplied to the gas passage can be reduced. From these facts, it is possible to prevent impurities contained in the gas from clogging at the jetting port and in the vicinity thereof.

As the third cause, the peripheral surface and inner peripheral surface (the outer surface of the square pillar portion 34 and the inner peripheral surface 43 of the second nozzle tip 40) of the gas passages 41a through 41d is coated with Teflon® to make it difficult for impurities to attach thereto. Thereby it is possible to prevent the impurities from clogging at the jetting port or in the vicinity thereof.

In the present invention, as described above, the gas passage open at the jetting port is partitioned into the four passages to reduce the amount of the gas flowing through each gas passage. Therefore it is possible to reduce noise which is generated at a jetting time.

Further the ratio of the volume of the gas to the volume of the liquid is set to 900 which is less than 1000. Thus it is possible to reduce the amount of the compressed gas to be used and hence reduce the cost. The gas to be supplied is not limited to the compressed gas supplied from a compressor, but a gas supplied from a blower can be used.

Furthermore the square pillar portion 34 of the first nozzle tip 30 contacts the inner peripheral surface 43 of the second nozzle tip 40 at the four positions. Therefore compared with a construction in which the first nozzle tip 30 is disposed in the second nozzle tip 40 with the gas passage formed on the entire periphery of the first nozzle tip 30, the construction of the nozzle of the first embodiment is capable of supporting the first nozzle tip 30 stably and facilitating an assembling work.

FIG. 8 shows the second embodiment. In the first embodiment, the nozzle tip is composed of the two component parts, namely, the first nozzle tip 30 and the second nozzle tip 40. In the second embodiment, the portion corresponding to the second nozzle tip 40 is formed integrally with a tip-accommodating portion 13′ of the nozzle body 1. That is, the nozzle tip consists of the first nozzle tip 30.

That is, the wall partitioning the liquid passage and the gas passage from each other is constructed of the peripheral wall of the first nozzle tip 30, but the peripheral wall of the gas passage is constructed of the peripheral wall of the tip-accommodating portion 13 of the nozzle body 1.

In the second embodiment, in the tip-accommodating portion 13′ of the nozzle body 1, through a stepped portion 13c′, a conic hole 13b′ is formed continuously with a front side of a hole 13′ in which the large-diameter portion 31 of the nozzle tip 30 is fitted. A small-diameter hole 13d′ sectionally circular is formed at a front end of the conic hole 13b′. Similarly to the first embodiment, the square pillar portion 34 of the nozzle tip 30 is fitted on the inner peripheral surface of the small-diameter hole 13d′ with the square pillar portion 34 in contact with the inner peripheral surface of the small-diameter hole 13d′ at four positions to form four separate gas passages 41a through 41d. Except the above-described construction, the second embodiment has the same construction as that of the first embodiment. Thus the same parts of the second embodiment as those of the first embodiment are denoted by the same reference numerals as those of the first embodiment, and description thereof is omitted herein.

The construction of the second embodiment is different from that of the first embodiment only because the second nozzle tip 40 is formed integrally with the nozzle body. Thus the operation and effect of the second embodiment having the above-described construction are similar to those of the first embodiment.

Although the construction of the second embodiment causes processing and molding operations for manufacturing the nozzle body to be performed complicatedly, it reduces the number of parts and the number of assembling steps.

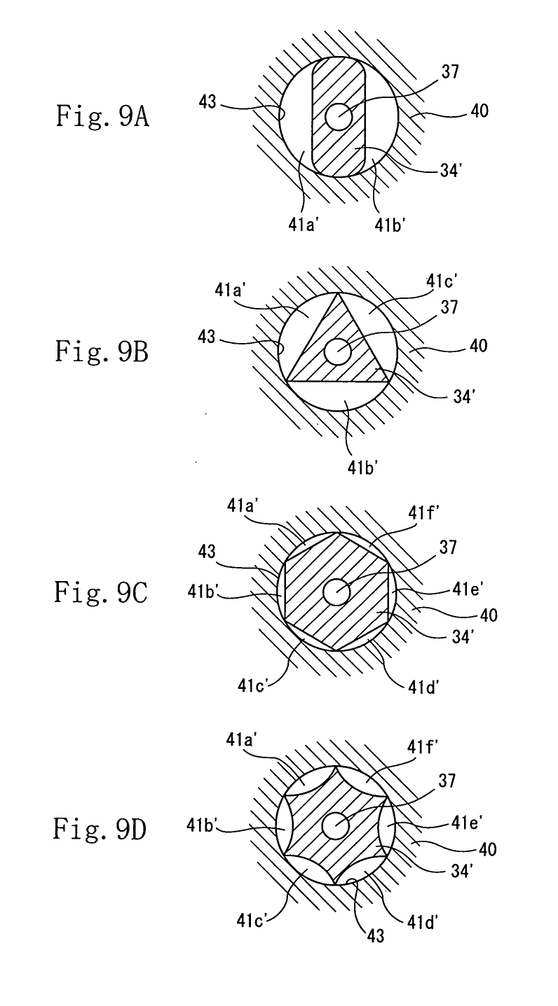

FIGS. 9A through 9D show other embodiments of the separate gas passages.

In the first and second embodiments, the outer configuration of the square pillar portion 34 of the first nozzle tip 30 is sectionally square, and the gas passage is divided into four regions. In the other embodiments, the gas passage disposed at the jetting-port side is divided into two, three, and six regions. It is appropriate to divide the gas passage into not more than eight passages. If the gas passage is divided into not less than nine passages, the sectional area of one gas passage is too small. As a result, the sectional area of the nozzle tip is too large in supplying a required amount of the gas, and the widest portion of each gas passage is too small. Consequently impurities are liable to clog.

In each of the gas passages shown in FIGS. 9A through 9D, the inner peripheral surface 43 of the second nozzle tip 40 is circular, and the liquid passage 37 sectionally circular is formed along the axis of the square pillar portion of the first nozzle tip 30.

Similarly to the second embodiment, the second nozzle tip may be formed integrally with the tip-accommodating portion of the nozzle body.

In the square pillar portion 34′ shown in FIG. 9A, opposed sides are straight, whereas the other two opposed sides form circular arcs. Thereby the gas passage is divided into two opposed gas passages 41a′ and 41b′.

The square pillar portion 34′ shown in FIG. 9B is sectionally triangular. The three apexes are in contact with the inner peripheral surface 43 of the second nozzle tip 40 to divide the gas passage into three regions 41a′ through 41c′.

The square pillar portion 34′ shown in FIG. 9C is sectionally hexagonal. The six apexes are in contact with the inner peripheral surface 43 of the second nozzle tip 40 to divide the gas passage into six regions 41a′ through 41f′.

Six concavities are circumferentially formed on the peripheral surface of the square pillar portion 34′ shown in FIG. 9D. Further six apexes are projected, with the six apexes in contact with the inner peripheral surface 43 of the second nozzle tip 40 to divide the gas passage into six regions 41a′ through 41f′. Thus the square pillar portion 34′ looks like a star.

In all of the above-described configurations shown in FIGS. 9A through 9D, supposing that the total of the sectional areas of the separate gas passages is S1 and that the sectional area of the liquid passage disposed at the center of the square pillar portion 34 is S2, the ratio of S1 to S2 is also set to 5:1 to 5:2.

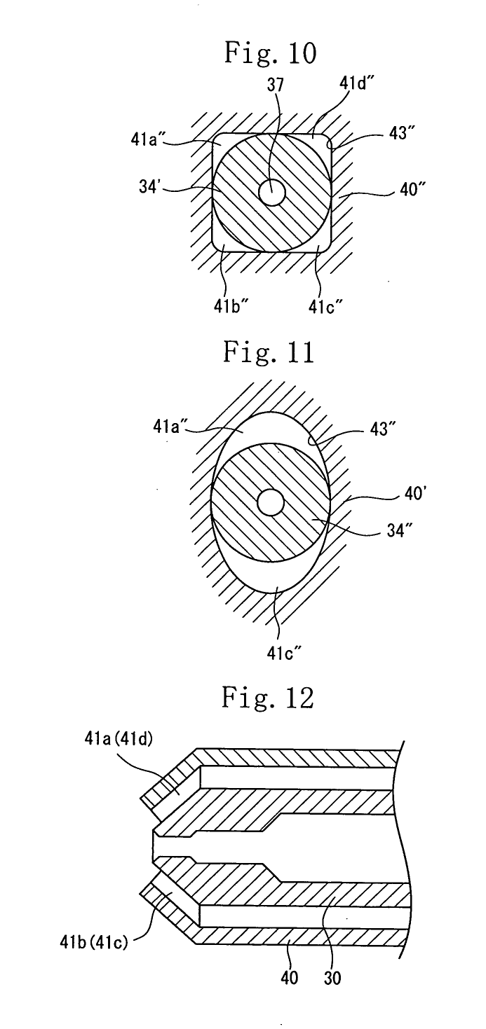

FIG. 10 shows the third embodiment. In the third embodiment, to divide the gas passage at the side of the jetting port, the hole of the second nozzle tip 40″ is formed in the shape of an approximate square. The inner surface 43″ of the second nozzle tip 40″ is constructed of four straight surfaces. The square pillar portion of the first nozzle tip 30 of the first embodiment is modified into a cylindrical portion 34″. Four separate gas passages 41a″ through 41d″ are formed between the peripheral surface of the cylindrical portion 34″ and the inner surface 43″ of the approximately square hole. The corners of the approximately square hole of the second nozzle tip 40 are rounded much.

FIG. 11 shows a modification of the third embodiment. The hole of the second nozzle tip 40′ is formed in the shape of an ellipse. Two gas passages 41a″ and 41c″ are formed between the peripheral surface of the cylindrical portion 34″ and the inner surface 43″ of the ellipse.

As shown in FIGS. 10 and 11, even when the gas passage at the side of the jetting port is divided into a plurality of passages by forming the first nozzle tip 30 as the cylindrical portion 34″ and the square hole on the second nozzle tip 40″, the operation and effect of the third embodiment are similar to those of the first embodiment.

In the third embodiment, similarly to the second modification of the first embodiment, the second nozzle tip may be formed integrally with the tip-accommodating portion of the nozzle body.

FIG. 12 shows the fourth embodiment. In the fourth embodiment, at the portion where the gas passage is divided into a plurality of passages 41a through 41d, the passages 41a through 41d are inclined toward the liquid-jetting port. The sectional areas of the passages 41a through 41d are equal to each other in a direction orthogonal to the axial direction of gas passage.

The above-described construction allows the gas to be jetted from the jetting port to the liquid jetted from the center of the nozzle tip. Thereby it is possible to accelerate the mixing of the liquid and the gas and atomize the liquid.

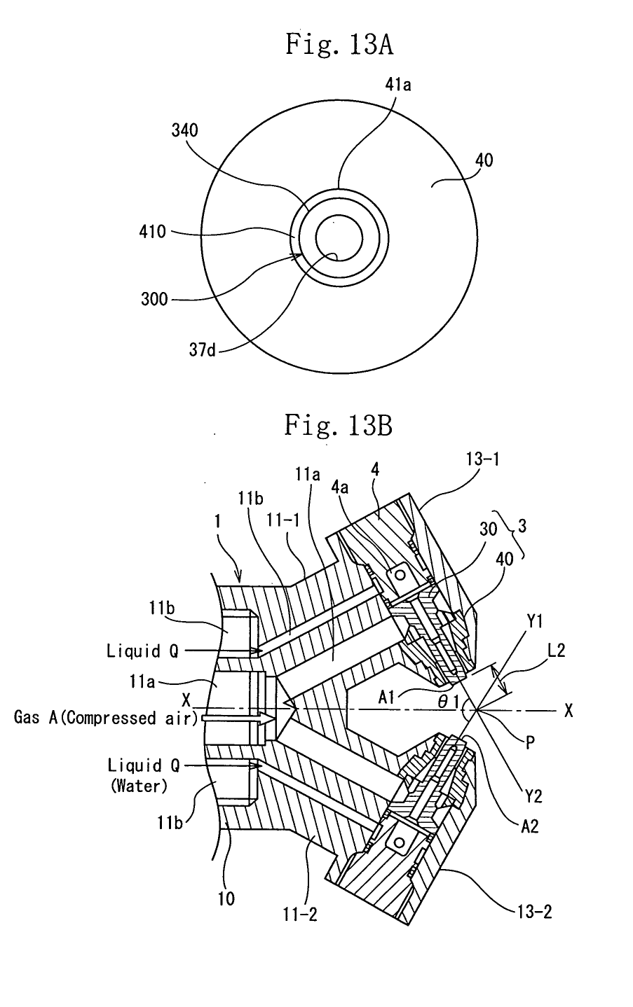

FIG. 13 shows the fifth embodiment. The nozzle of the fifth embodiment is different from those of the first through fourth embodiments in that the gas passage of the nozzle of the fifth embodiment is not partitioned circumferentially but a sectionally annular gas passage 410 is formed. More specifically, the portion of the a first nozzle tip 300 of the fifth embodiment corresponding to the square pillar portion 34 of the first nozzle tip 30 of the first embodiment is formed as a cylindrical portion 340 whose peripheral surface is sectionally circular. Thereby the gas passage 410 not partitioned circumferentially is provided between the cylindrical portion 340 and the sectionally circular inner peripheral surface of the second nozzle tip 400. Except the above-described construction, the fifth embodiment has the same construction as that of the first embodiment. Thus the same parts of the fifth embodiment as those of the first embodiment are denoted by the same reference numerals as those of the first embodiment, and description thereof is omitted herein.

In the fifth embodiment, the ratio of the volume of the gas to the volume of the liquid is set to less than 1000 and preferably 900 to 800.

Even though the gas passage is not partitioned and is annularly constructed, it is possible to prevent impurities from clogging in the gas passage 40 and reduce generated noise because the amount of air is reduced by setting the ratio of the volume of the gas to the volume of the liquid is set to less than 1000 and preferably 900 to 800. The fifth embodiment has the same operation and effect as those of the first embodiment. Thus description of the operation and effect of the fifth embodiment is omitted herein.

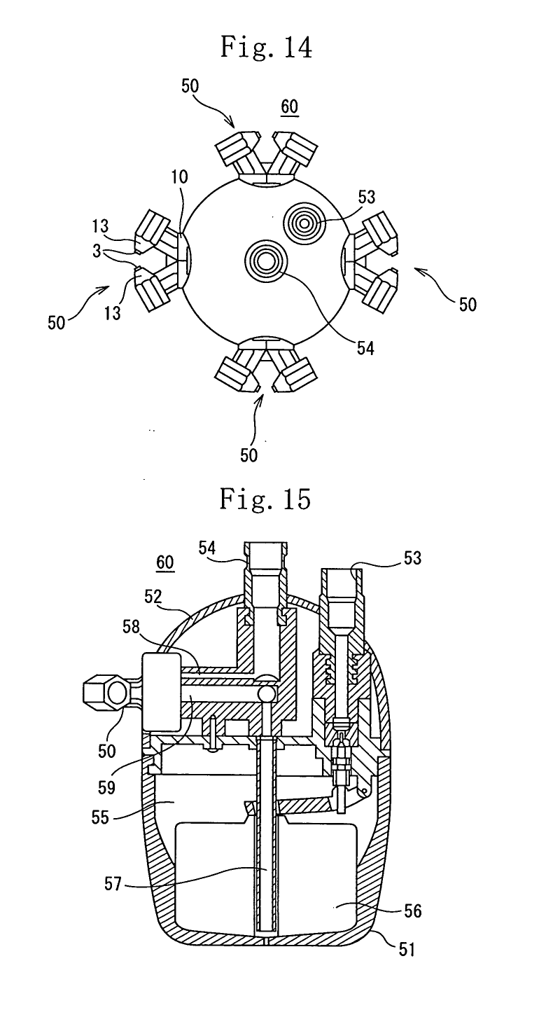

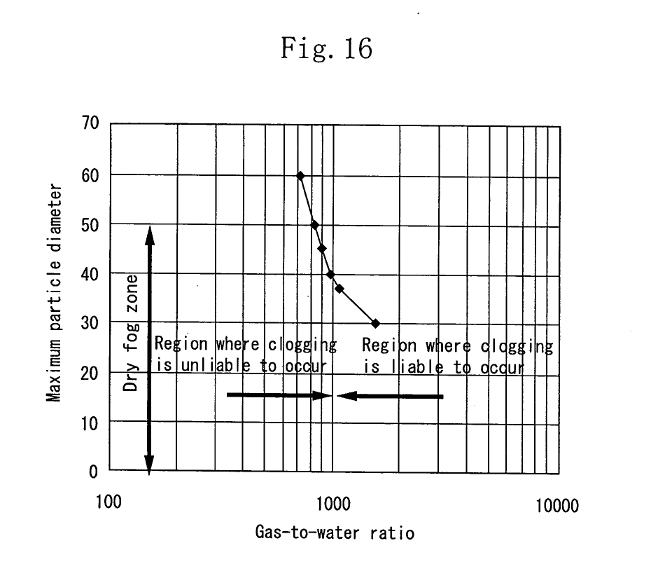

FIGS. 14 and 15 show the sixth embodiment. Four nozzles 50 of the first embodiment are mounted on the peripheral surface of a humidifier 60 at intervals of 90 degrees. The humidifier 60 has the same construction as that of the humidifier of the present applicant's U.S. Pat. No.2,843,970. The humidifier 60 has the body case 51, the cover case 52, the liquid supply pipe 53, the gas supply pipe 54, the storage chamber 55, the float 56 for controlling the liquid amount inside the storage chamber 55, the siphon 57, the gas passage 58, and the liquid passage 59.

Inside the humidifier 60, water inside the storage chamber 55 is sucked up to the liquid passage 59 from the siphon 57 and thereafter flows into the liquid passage described in the first embodiment. A gas flows into the gas passage of the nozzle 50 through the gas passage 58. As described in the first embodiment, when a mixture fluid of the gas and water is jetted from the front end of each of the nozzle-accommodating portions 11-1 and 11-2 disposed in confrontation with each other, the mixture fluids collide and mix with each other to generate ultra-fine spray having an average particle diameter of 10 μm.

The nozzle of the present invention is mounted on a humidifier, an air conditioner, and the like; is used for cooling component part, a dusting component part, a draining component part, and the like; and is used to jet an antiseptic solution or fuel oil. The nozzle is preferably used for apparatuses to which a liquid is required to be jetted without wetting it.

What is claimed is:

1. An ultra-fine spray-jetting nozzle comprising a liquid passage and a gas passage that is disposed on a peripheral side of said liquid passage through a partitioning wall and communicates with a jetting port,
wherein an outer surface of said partitioning wall at a jetting port side thereof is formed sectionally polygonal, long circular or elliptic; a peripheral surface of said gas passage is formed sectionally circular; said outer surface of said partitioning wall having said configuration is brought into contact with said sectionally circular peripheral surface of said gas passage at a plurality of positions to circumferentially divide said gas passage at said jetting side into a plurality of gas passages; or
said outer surface of said partitioning wall is formed sectionally circular; said peripheral surface of said gas passage at said jetting port side is formed sectionally polygonal, long circular or elliptic; said outer surface of said partitioning wall is brought into contact with said peripheral surface of said gas passage having said configuration at a plurality of positions to circumferentially divide said gas passage at said jetting side into a plurality of gas passages; and
a gas jetted from jetting ports of a plurality of said separate gas passages is mixed with a periphery of a liquid jetted from said liquid passage to generate spray.

2. The ultra-fine spray-jetting nozzle according to claim 1, wherein a jetting port of said liquid passage is projected outward from said jetting port of said gas passage; and said gas is jetted from said jetting port of said gas passages to said periphery of said liquid jetted from said liquid passage to mix said liquid and said gas with each other externally; and
jetting portions each including said liquid passage and said gas passage are disposed in confrontation with each other at a predetermined interval and at a predetermined angle; and mixture fluids of said gas and said liquid which have been generated externally at each of said jetting portions collide and mix with each other to set an average particle diameter of droplets to a range of 1 μm to 10 μm and a maximum particle diameter to not more than 50 μm.

3. The ultra-fine spray-jetting nozzle according to claim 1, wherein said liquid passage is formed along an axis of a first nozzle tip fitted on a tip-accommodating portion of a nozzle body; and said partitioning wall is constructed of a peripheral wall of said first nozzle tip; and
said gas passage is formed between said first nozzle tip and an inner peripheral surface of said tip-accommodating portion or between a second nozzle tip fitted on said tip-accommodating portion and said first nozzle tip; and a peripheral wall of said gas passage is constructed of said tip-accommodating portion or said second nozzle tip.

4. The ultra-fine spray-jetting nozzle according to claim 1, wherein sectional areas of a plurality of said gas passages are equal to each other; and
supposing that a total of said sectional areas of a plurality of said gas passages is Si and that a sectional area of a portion of said liquid passage surrounded with said gas passages is S2, a ratio of S1 to S2 is set to 5:1 to 5:2.

5. The ultra-fine spray-jetting nozzle according to claim 1, wherein a ratio of a volume of a gas to be supplied to said gas passage to a volume of a liquid to be supplied to said liquid passage is set to not less than 800 and less than 1000.

6. The ultra-fine spray-jetting nozzle according to claim 1, wherein an inner peripheral surface or/and a peripheral surface of each of a plurality of said separate gas passages are coated with a film made of fluororesin.

7. The ultra-fine spray-jetting nozzle according to claim 2, wherein said jetting port of said liquid passage is projected outward by 0.3 to 0.8 mm from said jetting port of said gas passage; an angle formed between axes of said opposed jetting portions is set to 70° to 160°; and a distance from each of said jetting portions to a point of collision of fluids is set to 3 to 15 mm.

8. The ultra-fine spray-jetting nozzle according to claim 2, wherein each of said separate gas passages has a substantially equal sectional area in an axial direction in a range from a gas inlet side to a gas-jetting port; a diameter of a peripheral wall of said liquid passage projected from said gas-jetting port decreases outward gradually; and a diameter of an inner peripheral surface of said jetting port of said liquid passage increases outward gradually.

9. The ultra-fine spray-jetting nozzle according to claim 8, wherein a cone angle of a portion of said jetting-side peripheral wall of said liquid passage projected from said gas passage is set to a range from 15° to 40°; and a cone angle of said jetting port of said liquid passage is set to a range from 90° to 170°.

10. The ultra-fine spray-jetting nozzle according to claim 3, wherein said nozzle body having said tip-accommodating portion and said nozzle tip are made of fluororesin that is injection-molded.

11. An ultra-fine spray-jetting nozzle in which a gas passage having a resin portion forming a smooth surface on at least an inner peripheral surface thereof is provided on a peripheral side of a liquid passage; a jetting port of said liquid passage is projected outward by 0.3 to 0.8 mm from a jetting port of said gas passage; a gas is jetted from said jetting port of said gas passages to a periphery of a liquid jetted from said liquid passage to mix said liquid and said gas with each other externally; jetting portions each including said liquid passage and said gas passage are disposed in confrontation with each other; an angle formed between axes of said opposed jetting portions is set to 70° to 160°; a distance from each of said jetting portions to a point of collision of fluids is set to 3 to 15 mm; and mixture fluids of said gas and said liquid which have been generated externally at each of said jetting portions collide and mix with each other to set an average particle diameter of droplets to a range of 1 μm to 10 μm and a maximum particle diameter to not more than 50 μm; and
a ratio of a volume of said gas to be supplied to said gas passage to a volume of said liquid to be supplied to said liquid passage is set to not less than 800 and less than 1000.

12. The ultra-fine spray-jetting nozzle according to claim 11, wherein said resin portion formed on said inner surface of said liquid passage is made of fluororesin; a cone angle of a portion of said jetting-side peripheral wall of said liquid passage projected from said gas passage is set to a range from 15° to 40°; and a cone angle of said jetting port of said liquid passage is set to a range from 90° to 170°.

13. A component part such as an air conditioner, a humidifier, a cooler, and the like on which an ultra-fine spray-jetting nozzle according to claim 1 is mounted.

14. A component part such as an air conditioner, a humidifier, a cooler, and the like on which an ultra-fine spray-jetting nozzle according to claim 11 is mounted.
